(19) United States
(12) Patent Application Publication
(10) Pub. No.: US 2026/0326925 A1
(43) Pub. Date: Oct. 22, 2026

(54) SATELLITE FOR HIGH-PERFORMANCE REMOTE SENSING

(71) Applicant: ALBEDO SPACE CORP., Broomfield, CO (US)

(72) Inventors: Warren Daniel Strong, Broomfield, CO (US); Ankur Chopra, Belmont, CA (US); Christopher Edward Haddad, Broomfield, CO (US); Andrew Jay Lasater, Denver, CO (US); Kevin William Kloster, Altadena, CA (US)

(21) Appl. No.: 19/104,783

(22) PCT Filed: Sep. 26, 2023
(86) PCT No.: PCT/US23/75154

§ 371 Date: Feb. 19, 2025

Related U.S. Application Data
(60) Provisional application No. 63/377,457, filed on Sep. 28, 2022.

(51) Int. Cl. B64G 1/24; B64G 1/10; G06V 20/13

(52) U.S. Cl. CPC B64G 1/242; B64G 1/1028; G06V 20/13

(57) ABSTRACT

A satellite includes a bus and a payload disposed relative to the bus. The payload includes a remote sensing system with a telescope that defines a line of sight. The bus is configured such that, in a cross-sectional plane that extends at least substantially normal relative to the line of sight, a bus outer profile defines an elongate shape that is at least substantially polygonal. A related method is also disclosed.

### CROSS-REFERENCE TO RELATED APPLICTION

This application claims priority to U.S. Provisional Patent Application No. 63/377,457, filed on Sep. 28, 2022, the contents of which are incorporated by reference herein in its entirety.

### TECHNICAL FIELD

The present disclosure generally relates to satellites for high-performance remote sensing of Earth during an orbit thereof.

### BACKGROUND

Satellites operate at a variety of orbital altitudes relative to Earth's surface. A low Earth orbit (LEO) satellite orbits the Earth within the altitude range of 100 km to 2,000 km. A medium Earth orbit (MEO) satellite orbits the Earth within the altitude range of 2,000 km to just below 35,786 km. A geosynchronous Earth orbit (GEO) satellite orbits the Earth at an altitude of approximately 35,786 km and typically has an orbital period equal to Earth's rotational period. A highly elliptical orbit (HEO) satellite orbits the Earth along an elliptical orbit with high eccentricity, such that the satellite's altitude ranges from a low perigee (i.e., point of orbit closest to Earth) altitude of under 1,000 km to a high apogee (i.e., point of orbit farthest from Earth) altitude of over 35,756 km.

A satellite includes a mission payload and numerous components that enable the mission payload to successfully complete a predetermined mission. Such components include, for example, flight computers, batteries, electrical power distribution, thermal control, attitude sensors, position sensors, attitude actuators, propulsion components, fuel, etc.

A satellite reaches orbit via rocket launch, which subjects the satellite to significant acceleration forces. The structure of the satellite must be designed to survive the rigors of the rocket launch and the space environment. This can increase the structural loads required to hold the mission payload by a factor of ten. Additionally, for high-performance remote sensing (e.g., visible imaging), the dynamic stability of the satellite and the mission payload must be maximized so that dynamic motion does not induce blur or smear in the collected imagery. These two factors lead to the need for fundamentally sound geometries for satellite support structures.

The technical challenges involved in designing and operating a satellite vary based on the intended orbital altitude (e.g., LEO, MEO, etc.) of the satellite. Many satellites are designed to operate within a LEO orbit, and the technical problems associated with lower LEO orbits can differ even from those associated with higher LEO orbits. For example, as orbital altitude decreases, the satellite must overcome Earth's atmospheric drag to remain in orbit. Maintaining altitude becomes increasingly difficult at very low Earth orbit (VLEO), during which the vehicle remains in the altitude range of 100 km to 450 km for an entirety of the orbit. This is because the VLEO region is a free molecular flow environment, in which the atmospheric density is high enough to cause significant drag on a vehicle, but too low to yield the benefit of generating lift. In the free molecular flow environment of VLEO, the shape of the satellite affects the effective coefficient of drag, which in turn affects the total atmospheric drag, propulsion requirements, and mission lifetime. Unlike in a higher density environment where airplanes operate and the atmosphere behaves as a fluid, shapes like airfoils and spheres do not see appreciable benefits on coefficients of drag. Thus, for VLEO operation, any increase in cross-sectional area of the vehicle significantly increases propulsion requirements and/or reduces mission lifetime. The atmospheric density at VLEO also produces torques and forces on the vehicle which present maneuverability problems that must be overcome. The VLEO region also has an increased presence of atomic oxygen, which can have a corrosive effect on unshielded (e.g., non-enclosed) vehicle components depending on material properties (e.g., polymers).

The technical challenges involved in designing and operating a satellite also vary based on the intended mission of the satellite. In satellites across a breadth of missions (e.g., electro-optical remote sensing, radio frequency signals collection, communications, space servicing, orbital tugs, etc.), there can be a distinct advantage in maximizing the area of the satellite that faces the Earth during orbit. This allows a larger aperture—a key driver in remote sensing performance across all forms (e.g., visible, thermal, radar, radio frequency, etc.)—pointed in the direction of Earth. It can also be a method to maximize volume for fuel, computer equipment, or other satellite hardware. For Earth observation remote sensing missions, such as visual imaging, a key technical parameter is image resolution, which can be improved by increasing the aperture that can face the Earth and/or decreasing the altitude. The desire to obtain ever-better remote sensing performance leads to technical challenges associated with operating remote sensing payloads with ever-larger Earth-facing apertures at ever-lower altitudes. As a result of these factors, volume to contain these components is typically a key design driver.

Other key design drivers include electric power management and thermal control. Satellites contain a variety of electrically-powered components, including components for computation, memory storage, attitude control, sensing, etc. The electric power used by these components produces significant waste heat that must be dissipated to maintain the components of the satellite within their operating temperature ranges. A satellite can only reject heat via radiative heat transfer, which is inefficient at the temperatures at which most satellites operate. A radiator is required to achieve the necessary radiative heat transfer. To be effective, the radiator should not have a view to the Sun.

To date, no publicly known satellite has achieved native image resolution better than 30 cm/pixel. This is due at least in part to the fact that VLEO vehicle concepts have limited volume in terms of visual imaging payload capacity. To overcome the above-mentioned problems associated with drag, existing VLEO vehicle concepts have been designed to minimize the cross-sectional area of the vehicle in the plane normal to the intended velocity direction (hereinafter the “ram-facing cross-sectional area”), while concurrently maximizing surface area for power generation (e.g., via solar panels) along the intended velocity direction, where it does not increase drag force. This trend in design strategy has led existing VLEO vehicles to look more like airplanes or tube-like structures than traditional satellites. The airplane or tube-like form factor associated with typical VLEO vehicle concepts, coupled with their flight profile with respect to the velocity direction during orbit, make it difficult or impossible for the vehicles to carry the types of large-aperture, Earth-facing payloads needed for better remote sensing performance. Adapting an existing VLEO vehicle concept to carry an imaging system with a sufficiently large aperture would invalidate streamlining design features that minimize ram-facing cross-sectional area.

Aspects of the present invention are directed to these and other problems.

### SUMMARY

According to an aspect of the present invention, a satellite includes a bus and a payload disposed relative to the bus. The payload includes a remote sensing system that defines a line of sight. The bus is configured such that, in a cross-sectional plane that extends at least substantially normal relative to the line of sight, a bus outer profile defines an elongate shape that is at least substantially polygonal.

According to another aspect of the present invention, a satellite is configured to generate a digital image of Earth during an orbit thereof. The digital image has a native resolution that is better than 30 cm/pixel.

According to another aspect of the present invention, a bus is configured for use with a satellite payload having a telescope that defines a line of sight. The bus includes a bus outer profile that defines an elongate shape in a cross-sectional plane extending at least substantially normal relative to the line of sight. The elongate shape is at least substantially polygonal.

According to another aspect of the present invention, a method is provided for operating a satellite having a bus and a payload disposed relative to the bus. The payload includes a remote sensing system with a telescope that defines a line of sight. The bus is configured such that, in a cross-sectional plane that extends at least substantially normal relative to the line of sight, a bus outer profile defines an elongate shape that is at least substantially polygonal. The method includes the step of maintaining a nominal attitude of the satellite in which a rotational symmetry axis of the bus outer profile extends at least substantially parallel relative to an intended velocity direction during a nominal orbit operation of the satellite.

In addition to, or as an alternative to, one or more of the features described above, further aspects of the present invention can include one or more of the following features, individually or in combination:
the remote sensing system is configured to generate digital images of Earth during a very low Earth orbit, the digital images having native resolution better than 30 cm/pixel;
the elongate shape of the bus outer profile is an elongate hexagonal shape;
the elongate shape of the bus outer profile corresponds to an equilateral polygonal shape that has been elongated at least in a direction that is substantially parallel relative to an intended velocity direction during a nominal orbit operation of the satellite;
the elongate shape of the bus outer profile is formed by a plurality of at least substantially straight sides that meet at a plurality of vertices;
the elongate shape of the bus outer profile is defined in part by a first ram-facing side and a second ram-facing side, and the elongate shape of the bus outer profile is rotationally symmetric about an axis that intersects a vertex where the first ram-facing side and the second ram-facing side meet to define a portion of a leading edge of the bus;
the axis extends at least substantially normal relative to the line of sight;
the bus outer profile is defined by at least a first ram-facing side, a second ram-facing side, a first parallel side, a second parallel side, a first wake side, and a second wake side, the first parallel side extends between the first ram-facing side and the first wake side, the second parallel side extends between the second ram-facing side and the second wake side, and the first and second parallel sides extend at least substantially parallel relative to one another;
the first parallel side and second parallel side each have a length that is greater than respective lengths of the first ram-facing side, the second ram-facing side, the first wake side, and the second wake side;
the satellite is configured such that the first parallel side and second parallel side of the bus outer profile are at least substantially parallel relative to an intended velocity direction during a nominal orbit operation of the satellite;
the first ram-facing side and the second ram-facing side meet to define a portion of a leading edge of the bus, the first wake side and the second wake side meet to define a portion of a trailing edge of the bus;
the bus has an at least substantially polyhedral shape such that, in at least a plurality of cross-sectional planes that each extend at least substantially normal relative to the line of sight, the bus outer profile has a same elongate shape that is at least substantially polygonal;
the elongate shape is an elongate hexagonal shape;
the payload is configured such that, in a second cross-sectional plane that extends normal relative to the line of sight, a payload outer profile defines an elongate shape that is at least substantially polygonal;
the elongate shape of the payload outer profile is different than the elongate polygonal shape of the bus outer profile;
the elongate shape of the bus outer profile is formed by n sides and the elongate shape of the payload outer profile is formed by n+1 sides;
the elongate shape of the payload outer profile is a truncated version the elongate polygonal shape of the bus outer profile;
the elongate shape of the payload outer profile corresponds to the elongate shape of the bus outer profile except the elongate shape of the payload outer profile includes an additional wake side;
the payload outer profile is defined by a first ram-facing side, a second ram-facing side, a first parallel side, a second parallel side, a first wake side, a second wake side, and a third wake side, the first parallel side extends between the first ram-facing side and the first wake side, the second parallel side extends between the second ram-facing side and the second wake side, the first and second parallel sides extend at least substantially parallel relative to one another, and the third wake side extends between the first and second wake sides;
the elongate shape of the payload outer profile is rotationally symmetric about an axis that intersects a vertex where the first ram-facing side and the second ram-facing side meet to define a portion of a leading edge of the payload, and the third wake surface is at least substantially normal relative to the axis;
the axis extends at least substantially normal relative to the line of sight;
the payload has an at least substantially polyhedral shape such that, in at least a plurality of cross-sectional planes that each extend at least substantially normal relative to the line of sight, the payload outer profile has a same elongate shape that is at least substantially polygonal;
the payload includes at least two star trackers configured to generate data indicative attitude of the satellite relative to a celestial reference, and each of the at least two star trackers is positionally fixed relative to a wake side of the payload such that a field of view of the respective star tracker is not obstructed by the bus;
the payload includes at least one thruster configured to generate thrust for a controllable duration for maintaining the satellite at a predetermined orbital altitude for a predetermined mission lifetime, and the at least one thruster is positionally fixed relative to a wake side of the payload;
the at least one thruster is an ion thruster;
the at least one thruster is configured to generate thrust for a controllable duration in a direction that is at least substantially opposite an intended velocity direction during a nominal orbit operation of the satellite;
the at least one thruster is configured to generate thrust for a controllable duration along a thrust axis that at least substantially intersects the center of mass of the satellite;
the bus and the payload define a leading edge of the satellite, and the leading edge extends at least substantially parallel to the line of sight;
the remote sensing system includes a telescope configured to collect and focus light, and an imaging sensor configured to transform the focused light from the telescope into digital image pixel data;
the telescope has an aperture with a diameter that is at least 20 cm;
the satellite includes a hot side and a cold side, the payload includes a payload frame to which a plurality of payload panels are positionally fixed to define a sealed internal cavity suitable for enclosing components such that the components are protected from at least one of direct exposure to light from the Sun and corrosive atomic oxygen in an ambient environment, a first subset of the plurality of payload panels are disposed on the hot side of the satellite, and a second subset of the plurality of payload panels are disposed on the cold side of the satellite, and payload panels of the first subset are solar panels, and payload panels of the second subset are not solar panels;
the satellite includes a hot side and a cold side, the bus includes a bus frame to which a plurality of bus panels are positionally fixed to define a sealed internal cavity suitable for enclosing components such that the components are protected from at least one of direct exposure to light from the Sun and corrosive atomic oxygen in an ambient environment, a first subset of the plurality of bus panels are disposed on the hot side of the satellite, and a second subset of the plurality of bus panels are disposed on the cold side of the satellite, and bus panels of the first subset are solar panels, and bus panels of the second subset are not solar panels;
satellite includes a plurality of solar panels, and the plurality of solar panels are all body-mounted solar panels;
the remote sensing system is configured to perform Earth imaging while maintaining a predetermined orbit for a predetermined mission lifetime;
the predetermined orbit is a very low Earth orbit, and the predetermined mission lifetime is more than 1 year; and
the native resolution is 10 cm/pixel or better.

These and other aspects of the present invention will become apparent in light of the drawings and detailed description provided below.

### BRIEF DESCRIPTION OF THE DRAWINGS

FIG. 1 schematically illustrates the present satellite during orbit around the Earth.

FIG. 2 provides another schematic illustration of the satellite of FIG. 1 during orbit around the Earth in a purely nadir-pointing example flight profile.

FIG. 3 is a schematic exploded view of a cross-section of the satellite of FIG. 1.

FIG. 4 illustrates the elongate hexagonal shape of the bus outer profile of the satellite of FIG. 1 in a cross-section normal relative to the line of sight.

FIG. 5 illustrates the elongate polygonal shape of the payload outer profile of the satellite of FIG. 1 in a cross-section normal relative to the line of sight.

FIG. 6 illustrates the elongate pentagonal shape of another bus outer profile having five (5) sides in a cross-section normal relative to the line of sight.

FIG. 7 illustrates the elongate septagonal shape of another bus outer profile having seven (7) sides in a cross-section normal relative to the line of sight.

FIG. 8 illustrates the elongate octagonal shape of another bus outer profile having eight (8) sides in a cross-section normal relative to the line of sight.

FIG. 9 is a perspective view of the satellite of FIG. 1.

FIG. 10 is another perspective view of the satellite of FIG. 1.

FIG. 11 is an elevation view of a side of the satellite of FIG. 1 showing body-mounted solar panels of the bus and the payload.

FIG. 12 is an elevation view of a cold side of the satellite of FIG. 1.

FIG. 13 is a plan view showing the zenith deck panel of the satellite of FIG. 1.

FIG. 14 is a plan view showing the nadir deck panel of the satellite of FIG. 1.

FIG. 15 is an exploded perspective view of the bus frame, the payload frame, and the telescope of the satellite of FIG. 1.

FIG. 16 schematically illustrates the elongate hexagonal shape of the bus outer profile of the satellite of FIG. 1 in a cross-section normal relative to the line of sight.

FIG. 17 schematically illustrates the square shape of the bus outer profile of a prior art satellite in a cross-section normal relative to the line of sight.

FIG. 18 schematically illustrates the equilateral hexagonal shape of the bus outer profile of a prior art satellite in a cross-section normal relative to the line of sight.

FIG. 19 is a plot showing how the present satellite compares to prior art space vehicles in terms of remote sensing system size and propulsion requirements.

### DETAILED DESCRIPTION

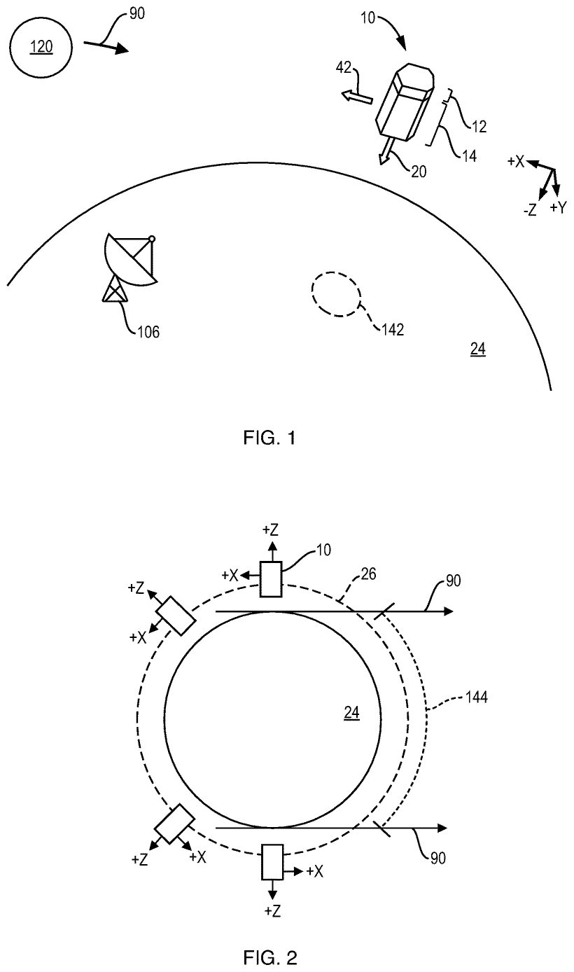

Referring to FIGS. 1 and 2, the present disclosure describes a satellite 10 and a related method for operating the satellite 10.

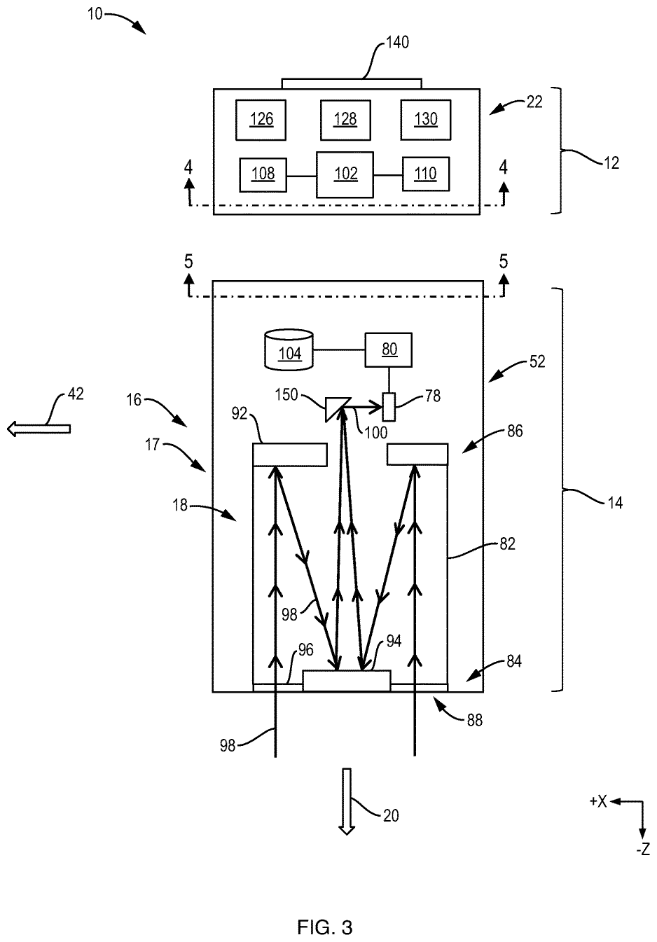

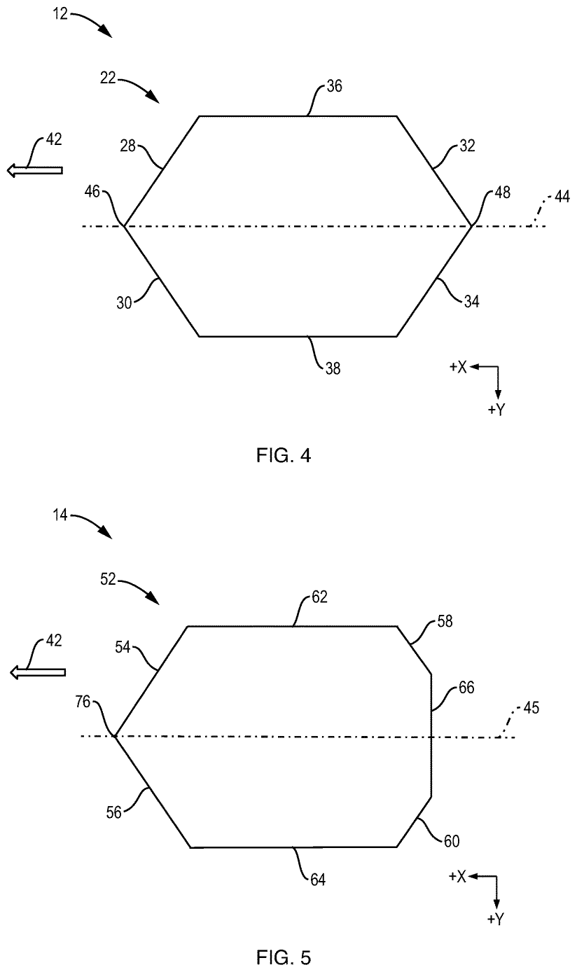

Referring to FIG. 3, the satellite 10 includes a bus 12 and a payload 14 disposed relative to the bus 12. The payload 14 includes a remote sensing system 16 that defines a line of sight 20. The bus 12 is configured such that, in a cross-sectional plane (FIG. 4) that extends at least substantially normal relative to the line of sight 20, a bus outer profile 22 defines an elongate shape that is at least substantially polygonal (hereinafter the “elongate polygonal shape” of the bus outer profile 22). The elongate polygonal shape of the bus outer profile 22 is an unconventional design that advantageously allows the satellite 10 to maintain a low orbital altitude (e.g., a LEO altitude, a VLEO altitude, etc.) while providing maximum volume for infrastructure that enables the remote sensing system 16 to generate high-performance remote sensing data (e.g., digital image pixel data with resolution better than 30 cm/pixel) of Earth 24 during an orbit 26 thereof, as will be discussed in more detail below.

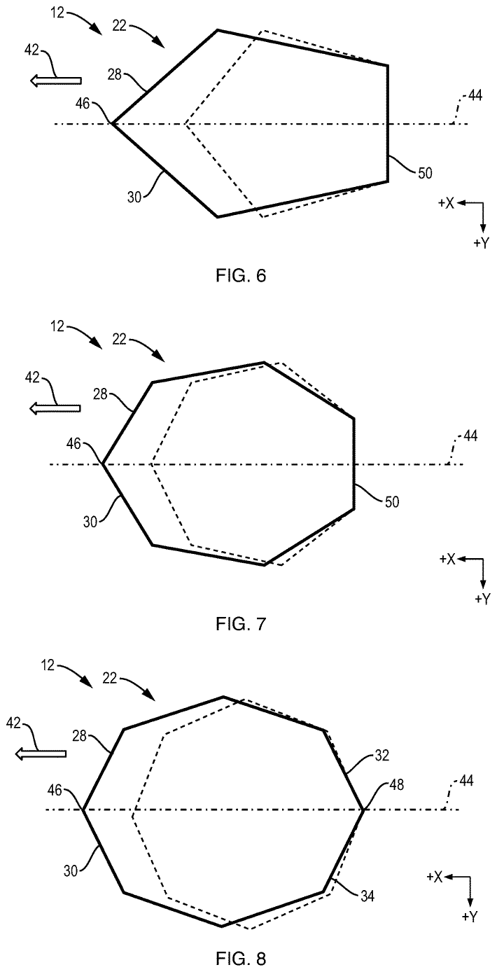

Referring to FIG. 4, the elongate polygonal shape of the bus outer profile 22 is formed by a plurality of at least substantially straight sides that meet at a plurality of vertices. The number of sides that form the elongate polygonal shape of the bus outer profile 22 can vary. In the illustrated embodiment, the elongate polygonal shape of the bus outer profile 22 is an elongate hexagonal shape formed by six (6) sides, including two ram-facing sides 28, 30, two wake sides 32, 34, and two parallel sides 36, 38 extending between the ram-facing sides 28, 30 and the wake sides 32, 34. Referring to FIGS. 6-8, in other embodiments, the elongate polygonal shape of the bus outer profile 22 is an elongate pentagonal shape formed by five (5) sides (see FIG. 6), an elongate septagonal shape formed by seven (7) sides (see FIG. 7), an elongate octagonal shape formed by eight (8) sides (see FIG. 8), or an elongate polygonal shape with nine (9) or more sides (not shown).

The elongate polygonal shape of the bus outer profile 22 is an irregular (i.e., not equilateral) polygonal shape. That is, the sides that form the elongate polygonal shape of the bus outer profile 22 are not all of equal size. In some embodiments, the elongate polygonal shape of the bus outer profile 22 corresponds to a regular (i.e., equilateral) polygonal shape that has been elongated in at least one direction. In some embodiments, the longest sides of the elongate polygonal shape of the bus outer profile 22 extend at least substantially parallel relative to one another, and extend at least substantially parallel relative to the intended velocity direction 42 during a nominal orbit operation of the satellite 10. Referring to FIGS. 4 and 6-8, in the illustrated embodiments, the elongate polygonal shape of the bus outer profile 22 corresponds to a regular polygonal shape (see dashed lines in FIGS. 6-8) that has been elongated in a direction of a rotational symmetry axis 44 to form an irregular polygonal shape having a same number of sides as the regular polygonal shape. The rotational symmetry axis 44 lies in the same cross-sectional plane in which the elongate polygonal shape of the bus outer profile 22 is defined. The rotational symmetry axis 44 extends at least substantially normal relative to the line of sight 20, and intersects the vertex where two ram-facing sides 28, 30 meet to define a portion of the leading edge 46 of the bus 12. In some embodiments, such as those in which the elongate polygonal shape is formed by an even number of sides (see FIGS. 4 and 8), the rotational symmetry axis 44 also intersects a vertex where two wake sides 32, 34 meet to define a portion of the trailing edge 48 of the bus 12. In such embodiments, the rotational symmetry axis 44 is at least substantially parallel to the intended velocity direction 42 during nominal orbit operation of the satellite 10. In other embodiments, such as those in which the elongate polygonal shape is formed by an odd number of sides (see FIGS. 6 and 7), the rotational symmetry axis 44 also intersects a wake surface 50 that extends at least substantially normal relative to the intended velocity direction 42 during a nominal orbit operation of the satellite 10.

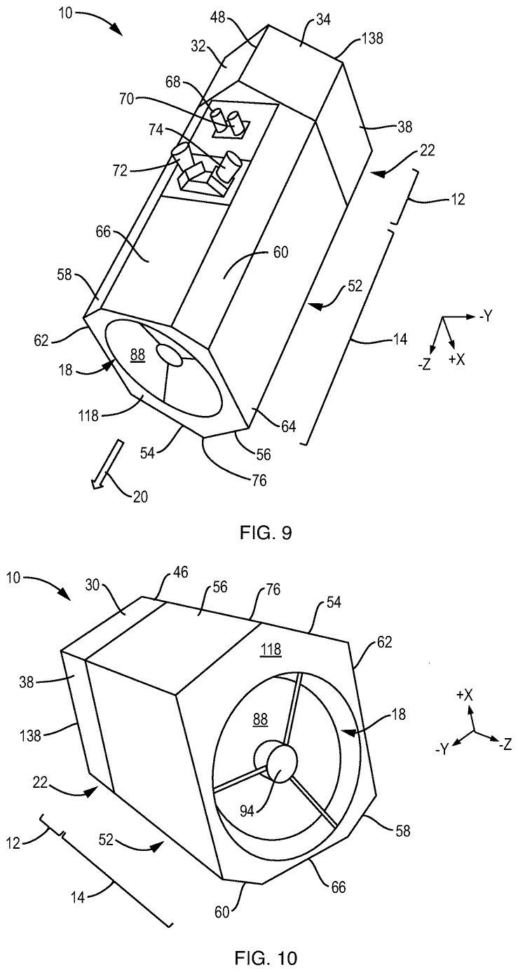

In some embodiments, the bus 12 is configured to have an at least substantially polyhedral shape such that, in at least a plurality of cross-sectional planes that each extend at least substantially normal relative to the line of sight 20, the bus outer profile 22 has an elongate polygonal shape as described above. Referring to FIGS. 9 and 10, in the illustrated embodiment, the bus 12 has a polyhedral shape such that the bus outer profile 22 has a same elongate hexagonal shape (see FIG. 3) in all cross-sectional planes extending normal relative to the line of sight 20 (e.g., a hexagonal prism shape). The polyhedral shape of the bus 12 is such that the leading edge 46 of the bus 12 extends along an axis that is at least substantially parallel to the line of sight 20. In other embodiments not shown in the drawings, the bus 12 has a polyhedral shape such that the bus outer profile 22 has a first elongate polygonal shape in at least a first cross-sectional plane extending at least substantially normal relative to the line of sight 20, a second elongate polygonal shape in at least a second cross-sectional plane extending at least substantially normal relative to the line of sight 20, and the first and second elongate polygonal shapes are different from one another. For example, in some such embodiments, the first elongate polygonal shape is a first elongate hexagonal shape extending a first length in the direction of the rotational symmetry axis 44, the second elongate polygonal shape is a second elongate hexagonal shape extending a second length in the direction of the rotational symmetry axis 44, and the first and second lengths have different magnitudes.

Referring to FIGS. 3 and 5, in some embodiments, the payload 14 is configured such that, in a cross-sectional plane (FIG. 5) that extends at least substantially normal relative to the line of sight 20, a payload outer profile 52 also defines an elongate shape that is at least substantially polygonal (hereinafter the “elongate polygonal shape” of the payload outer profile 52). The elongate polygonal shape of the payload outer profile 52 further enables the satellite 10 to operate at low altitudes (e.g., LEO altitudes, VLEO altitudes, etc.) while providing sufficient enclosure for a remote sensing system 16 capable of generating high-performance remote sensing data (e.g., digital image pixel data with resolution better than 30 cm/pixel) of Earth 24 during an orbit 26 thereof, as will be discussed in more detail below.

Referring to FIGS. 4 and 5, in some embodiments, the elongate polygonal shape of the payload outer profile 52 (FIG. 5) is different than the elongate polygonal shape of the bus outer profile 22 (FIG. 4). In some such embodiments, the elongate polygonal shape of the bus outer profile 22 is formed by n sides and the elongate polygonal shape of the payload outer profile 52 is formed by n+1 sides. In the illustrated embodiment, the elongate polygonal shape of the payload outer profile 52 (FIG. 5) is a non-uniformly truncated (hereinafter “truncated”) version of the elongate polygonal shape of the bus outer profile 22 (FIG. 4). That is, the elongate polygonal shape of the payload outer profile 52 (FIG. 5) corresponds to the elongate hexagonal shape of the bus outer profile 22 (FIG. 4) but includes an additional wake side, which can be used to provide maximum radiator surface area on a nominally cold-facing side of the satellite 10 for thermal control, as will be discussed in more detail below. Referring to FIG. 5, the elongate polygonal shape of the payload outer profile 52 is formed by seven (7) sides, include two ram-facing sides 54, 56, two converging wake sides 58, 60, two parallel sides 62, 64 extending between the ram-facing sides 54, 56 and the converging wake sides 58, 60, and the additional wake side 66 that extends between the two converging wake sides 58, 60. The additional wake side 66 is oriented normal relative to the rotational symmetry axis 45.

In other embodiments, the elongate polygonal shape of the payload outer profile 52 is at least substantially the same as the elongate polygonal shape of the bus outer profile 22. In some such embodiments, the bus outer profile 22 and the payload outer profile 52 have at least substantially the same elongate polygonal shape that has been truncated as shown in FIG. 5 and described above, for example.

In some embodiments, the payload 14 is configured to have an at least substantially polyhedral shape such that, in at least a plurality of cross-sectional planes that each extend at least substantially normal relative to the line of sight 20, the payload outer profile 52 has an elongate polygonal shape as described above. Referring to FIG. 9, in the illustrated embodiment, the payload 14 has a polyhedral shape such that the payload outer profile 52 has a same elongate hexagonal shape (see FIG. 4) in all cross-sectional planes extending normal relative to the line of sight 20, except the cross-sectional planes where supporting equipment extends from the wake side 66 of the payload 14. In the illustrated embodiment, the supporting equipment includes the thrusters 68, 70 and inertial sensors 72, 74 that will be discussed in more detail below. In other embodiments, the supporting equipment additionally or alternatively includes other equipment, such as an inter-satellite optical relay link. In the illustrated embodiment, the polyhedral shape of the payload 14 is such that the leading edge 76 of the payload 14 extends along an axis that is at least substantially parallel to the line of sight 20. Moreover, the leading edge 76 of the payload 14 and the leading edge 46 of the bus 12 are aligned such that they form a continuous leading edge of the satellite 10.

Referring again to FIG. 3, in the illustrated embodiment, the remote sensing system 16 of the payload 14 includes a visible imaging system 17 that defines the line of sight 20. In other embodiments, the remote sensing system 16 additionally or alternatively includes one or more other systems or components that define a same or different line of sight that intersects a portion of the Earth during a nominal orbit operation of the satellite 10, including, for example, a thermal imaging system, a multispectral imaging system, a hyperspectral imaging system, radio frequency signal collection system, synthetic imaging radar system, light ranging and detection system, etc.

Referring still to FIG. 3, in the illustrated embodiment, the visible imaging system 17 includes a telescope 18 and a visible imaging sensor 78. The telescope 18 is configured to collect and focus electromagnetic radiation including at least visible light 98 (hereinafter “light 98”). The imaging sensor 78 is configured to receive a focused visible light beam 100 from the telescope 18 and to digitize the light beam 100, generating digital image pixel data with a native resolution better than 30 cm/pixel, which has never been achieved by publicly known Earth observing satellites. In some embodiments, the resolution is approximately 29 cm/pixel, 28 cm/pixel, 27 cm/pixel, 26 cm/pixel, 25 cm/pixel, 24 cm/pixel, 23 cm/pixel, 22 cm/pixel, 21 cm/pixel, 20 cm/pixel, 19 cm/pixel, 18 cm/pixel, 17 cm/pixel, 16 cm/pixel, 15 cm/pixel, 14 cm/pixel, 13 cm/pixel, 12 cm/pixel, 11 cm/pixel, 10 cm/pixel, 9 cm/pixel, 8 cm/pixel, or better.

Referring still to FIG. 3, in the illustrated embodiment, the telescope 18 has a barrel 82 extending axially between a forward end 84 and an aft end 86. The forward end 84 of the barrel 82 defines a clear aperture 88 through which light 98 passes and enters the barrel 82. The light 98 passing through the aperture 88 includes a light ray that is anti-parallel relative to the line of sight 20 (e.g., in a positive z-axis direction). The aperture 88 has a maximum straight-line dimension (e.g., an effective diameter) that is greater than 20 cm. For example, in some embodiments, the satellite 10 obtains digital image pixel data with resolution better than 30 cm/pixel using an aperture 88 with an effective diameter of 23 cm at 250 km altitude. In some embodiments, the aperture 88 has a maximum straight-line dimension (e.g., an effective diameter) that is greater than 50 cm. For example, in some embodiments, the satellite 10 obtains digital image pixel data with resolution better than 15 cm/pixel using an aperture 88 with an effective diameter of 50 cm at 250 km altitude. In some embodiments, the effective diameter of the aperture 88 is 51 cm, 52 cm, 53 cm, 54 cm, 55 cm, 56 cm, 57 cm, 58 cm, 59 cm, 60 cm, 61 cm, 62 cm, 63 cm, 64 cm, 65 cm, 66 cm, 67 cm, 68 cm, 69 cm, 70 cm, 71 cm, 72 cm, 73 cm, 74 cm, 75 cm, 76 cm, 77 cm, 78 cm, 79 cm, 80 cm, 81 cm, 82 cm, 83 cm, 84 cm, 85 cm, or more.

The telescope 18 can be configured in various different ways. In the illustrated embodiment, the telescope 18 is a Ritchey-Chrétien telescope with a primary mirror 92 disposed within the barrel 82 proximate the aft end 86, and a secondary mirror 94 disposed within the barrel 82 proximate the forward end 84. The telescope 18 is configured such that light 98 passes through the aperture 88 and within the barrel 82 to the primary mirror 92. The light 98 is collected, focused, and reflected by the primary mirror 92, and then travels back toward the forward end 84 of the barrel 82. The light 98 is then focused and reflected off of the secondary mirror 94, followed by a tertiary mirror 150, which concentrate the light 98 into a light beam 100 that is directed onto a light-sensitive surface of the imaging sensor 78. As discussed above, the imaging sensor 78 is configured to receive a focused visible light beam 100 from the telescope 18 and digitize the light beam 100, generating digital image pixel data that is ultimately processed into a digital image. In other embodiments, the telescope 18 includes another type of reflecting telescope, including a three-mirror anistigmat telescope, a four-mirror anistigmat telescope, or a Cassegrain telescope, for example. In some such embodiments, the telescope 18 omits the tertiary mirror 150, for example.

Referring still to FIG. 3, in the illustrated embodiment, the payload 14 further includes a payload processor 80 configured to collect data from the remote sensing system 16 (e.g., the digital image pixel data from the imaging sensor 78) and transfer the data to an on-board memory device 104 for at least temporary storage and/or a mission controller 102 provided in the bus 12 for downlinking to Earth 24 via a ground station 106 (see FIG. 1). In some embodiments, the data is transmitted from the satellite 10 to the ground station 106 via one or more relay satellites (not shown). In some embodiments, the payload processor 80 is configured to perform at least one data processing function (e.g., online calibration or data compression) relative to the data received from the remote sensing system 16 before the data is transferred to the memory device 104 and/or the mission controller 102.

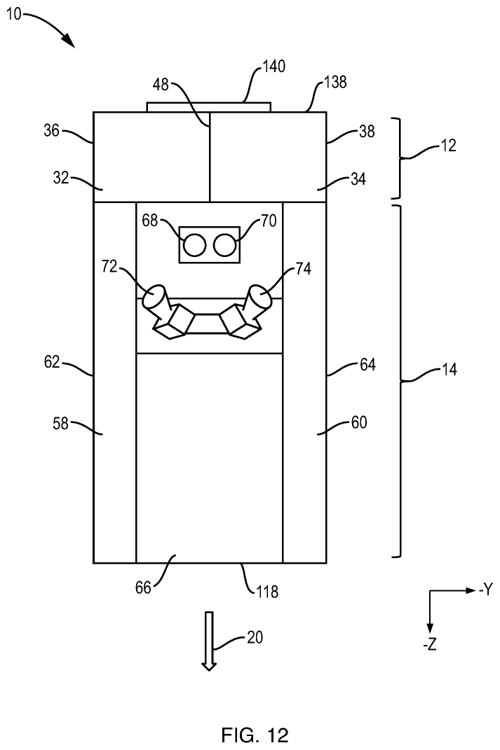

In some embodiments, the payload 14 further includes one or more inertial sensors 72, 74 configured to generate measurements indicative of the attitude of the satellite 10 relative to a celestial reference. Referring to FIGS. 9 and 12, in the illustrated embodiment, the payload 14 includes two (2) inertial sensors 72, 74 that are each in the form of a star tracker positionally fixed relative to the wake side 66 of the payload 14 (hereinafter “star trackers 72, 74”). Each star tracker 72, 74 defines a fixed field of view, and is oriented relative to the bus 12 such that the bus 12 does not obstruct the field of view. In other embodiment, one or more portions of the satellite 10 other than the payload 14 additionally or alternatively include one or more star trackers.

In some embodiments, the payload 14 further includes one or more thrusters 68, 70 configured to generate thrust for a controllable duration for maintaining the satellite 10 at a predetermined orbital altitude (e.g., a LEO altitude, a VLEO altitude) over a predetermined mission lifetime (e.g., 1 year, 2 years, 3 years, 4 years, etc.). Referring to FIGS. 9 and 12, in the illustrated embodiment, the payload 14 includes two (2) ion thrusters 68, 70 that are each configured to generate thrust for a controllable duration by accelerating a propellant (e.g., Xenon) using an electric field. Each of the thrusters 68, 70 includes a nozzle that is positionally fixed relative to the wake side 66 of the payload 14. Each thruster 68, 70 is configured to generate thrust for a controllable duration in a fixed direction that is at least substantially opposite the intended velocity direction 42 during a nominal orbit operation of the satellite 10, and along a respective thrust axis that intersects the center of mass of the satellite 10.

In some embodiments, the payload 14 further includes a thermal management system configured to keep one or more components of the payload 14 within acceptable temperature ranges.

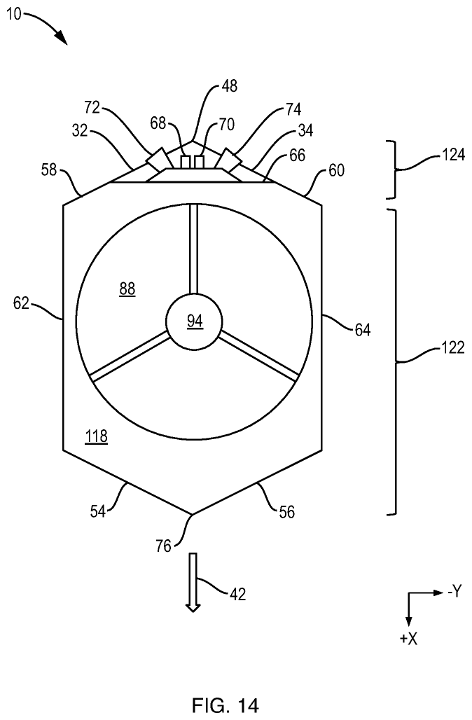

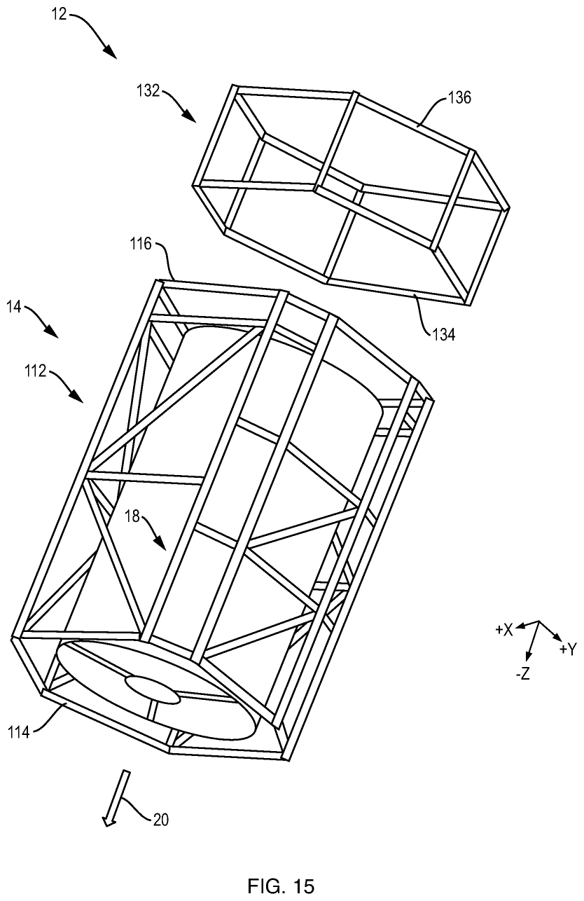

Referring to FIG. 15, in the illustrated embodiment, the payload 14 includes a payload frame 112 to which a plurality of payload panels (see FIGS. 5, 9-14, and 16) are positionally fixed.

Referring still to FIG. 15, the payload frame 112 is formed by a plurality of stiff struts positionally fixed relative to one another in a predetermined geometric pattern. In the illustrated embodiment, the payload frame 112 is configured such that, in a cross-sectional plane that extends normal relative to the line of sight 20, the payload frame 112 defines an elongate polygonal shape that corresponds to the elongate polygonal shape of the payload outer profile 52 discussed above in reference to FIG. 5. The payload frame 112 extends between a nadir end 114 and a bus interface end 116 in a direction of the line of sight 20. The payload 14 includes a nadir deck panel 118 (see FIGS. 9, 10, 11, 12, and 14) positionally fixed relative to the nadir end 114 of the payload frame 112. In other embodiments, the payload frame 112 is additionally or alternatively formed by other structural support elements. In some embodiments, one or more of the structural support elements of the payload frame 112 is additively manufactured.

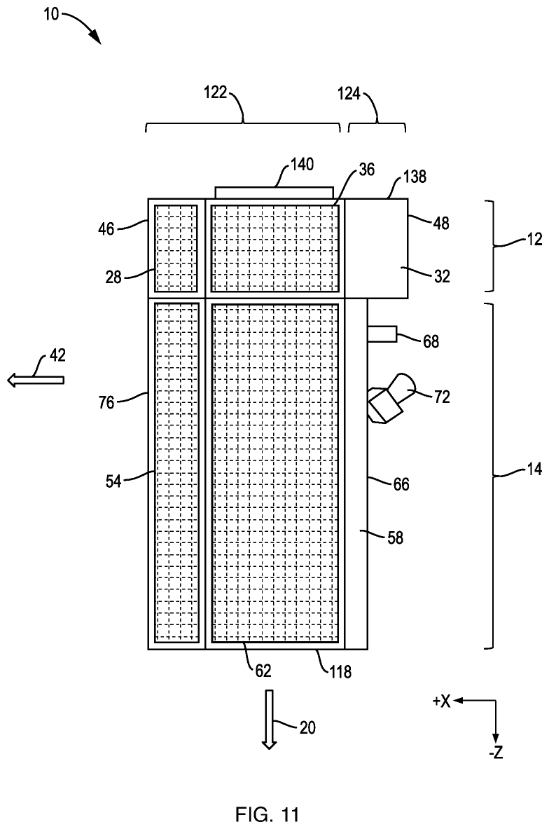

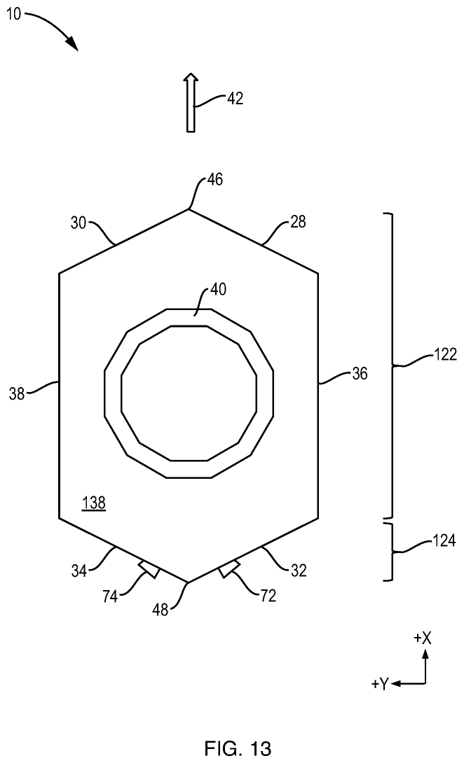

In the illustrated embodiment, the payload panels are fixed to the payload frame 112 such that they define a sealed (e.g., light-sealed) internal cavity suitable for enclosing components such that they are protected from at least one of: direct exposure to light 90 from the Sun 120 (see FIG. 1) and/or another light source; and corrosive atomic oxygen in an ambient environment (e.g., a VLEO environment). The payload panels define the seven sides 54, 56, 58, 60, 62, 64, 66 of the payload 14 described above in reference to FIG. 5. At least one of the payload panels is a solar panel with photo-voltaic cells configured to convert incident light 90 from the Sun 120 (see FIG. 1) and/or another ambient light source into electricity that can be stored for use by one or more components of the satellite 10 (e.g., the thrusters 68, 70). Referring to at least FIGS. 5, 9-12, and 14, the payload panels defining the two ram-facing sides 54, 56 and the two parallel sides 62, 64 of the payload 14 are defined by solar panels, while the three wake sides 58, 60, 66 of the payload 14 are defined by panels without photo-voltaic cells (hereinafter “non-solar panels”). Referring to FIGS. 11 and 13, in the illustrated embodiment, the satellite 10 includes a hot side 122 and a cold side 124, as will be discussed in more detail below. The payload panels on the hot side 122 of the satellite 10 are all solar panels (shown in FIG. 11 only), while the payload panels on the cold side 124 of the satellite 10 are all non-solar panels. The payload panels are positionally fixed to the payload frame 112 and define portions of the payload outer profile 52, and thus the payload panels may be characterized as “frame-mounted” or “body-mounted” panels. In the illustrated embodiment, all of the solar panels of the payload 14 are body-mounted solar panels. In other embodiments, the payload 14 includes at least one solar panel that is not a body-mounted, such as a flip-out solar panel.

Referring to FIG. 3, the bus 12 includes infrastructure that enables the payload 14 to generate high-performance remote sensing data (e.g., digital image pixel data with native resolution better than 30 cm/pixel) of Earth 24 while nominally maintaining the predetermined orbital altitude (e.g., a LEO altitude, a VLEO altitude) for the predetermined mission lifetime (e.g., 1 year, 2 years, 3 years, 4 years, etc.).

Referring still to FIG. 3, in the illustrated embodiment, the bus 12 includes a mission controller 102, a fuel tank 126, an attitude control device 128, and one or more momentum exchange devices 130 (e.g., attitude control actuators).

The mission controller 102 is configured to transfer the remote sensing data received from the payload controller 80 (e.g., the digital image pixel data) to a ground station 106 (see FIG. 1) via at least one signal transmitter 108 included on the satellite 10. The mission controller 102 is in signal communication with at least the payload controller 80 via one or more wired or wireless connections (not shown in FIG. 3). In some embodiments, the mission controller 102 is further configured to receive signals from the ground station 106 (see FIG. 1) via at least one signal receiver 110 included on the satellite 10.

The fuel tank 126 stores fuel (e.g., Xenon, Krypton, another noble gas, lodine, etc.) for use by the ion thrusters 68, 70 of the payload 14.

The attitude control device 128 is configured to receive data from the one or more star trackers 72, 74 indicative of an attitude of the satellite 10 relative to a celestial reference (hereinafter “star tracker data”). The attitude control device 128 is configured to execute at least one algorithm that generates an attitude control signal based at least in part on the star tracker data. The attitude control device 128 is configured to transmit the attitude control signal to one or more components of the satellite 10 (e.g., the thrusters 68, 70, the momentum exchange devices 130, etc.) for actuating or otherwise controlling such components in a manner that provides 3-axis stabilization and effects desired changes to the attitude of the satellite 10. The attitude control device 128 is in signal communication with at least the star trackers 72, 74, the thrusters 68, 70, and/or the momentum exchange devices 130 via one or more wired or wireless connections (not shown in FIG. 3). In some instances, the attitude control device 128 in the bus 12 communicates with the star trackers 72, 74 and/or the thrusters 68, 70 via the mission controller 102 and/or the payload controller 80.

The functionality of the payload controller 80, the mission controller 102, and/or the attitude control device 128 can be implemented using analog and/or digital hardware (e.g., counters, switches, logic devices, memory devices, programmable processors, non-transitory computer-readable storage mediums), software, firmware, or a combination thereof. The payload controller 80, the mission controller 102, and/or the attitude control device 128 can perform one or more of the functions described herein by executing software, which can be stored, for example, in a memory device. Although the payload controller 80, the mission controller 102, and/or the attitude control device 128 are described as being discrete components, in other embodiments the payload controller 80, the mission controller 102, and/or the attitude control device 128, or one or more components thereof, can be combined into a single component.

Referring to FIG. 15, in the illustrated embodiment, the bus 12 includes a bus frame 132 to which a plurality of bus panels (see FIGS. 4, 9-14, and 16) are positionally fixed.

Referring to FIG. 15, the bus frame 132 is formed by a plurality of stiff struts positionally fixed relative to one another in a predetermined manner. In the illustrated embodiment, the bus frame 132 is configured such that, in a cross-sectional plane that extends normal relative to the line of sight 20, the bus frame 132 defines an elongate polygonal shape that corresponds to the elongate polygonal shape of the bus outer profile 22 discussed above in reference to FIG. 4. In other embodiments, the bus frame 132 is additionally or alternatively formed by other structural support elements. In some embodiments, one or more of the structural support elements of the bus frame 132 is additively manufactured.

Referring to FIG. 15, the bus frame 132 extends between a payload interface end 134 and a zenith end 136 in a direction of the line of sight 20.

The bus 12 includes a zenith deck panel 138 (see FIGS. 9, 10, 11, 12, 14, and 16) positionally fixed relative to the zenith end 136 of the bus frame 132. In the illustrated embodiment, the satellite 10 further includes a launch vehicle adapter 140 mounted to the zenith deck panel 138 of the bus 12.

The bus panels are fixed to the bus frame 132 such that they define a sealed (e.g., light-sealed) internal cavity suitable for enclosing components such that they are protected from at least one of: direct exposure to light 90 from the Sun 120 (see FIG. 1) and/or another light source; and corrosive atomic oxygen in an ambient environment (e.g., a VLEO environment). The bus panels define the six sides 28, 30, 32, 34, 36, 38 of the bus 12 described above in reference to FIG. 4. At least one of the bus panels is a solar panel with photo-voltaic cells configured to convert incident light 90 from the Sun 120 (see FIG. 1) and/or another ambient light source into electricity that can be stored (e.g., in a battery) for use by one or more components of the satellite 10 (e.g., the thrusters 68, 70, the star trackers 72, 74, etc.). Referring to at least FIGS. 4 and 9-13, the bus panels defining the two ram-facing sides 28, 30 and the two parallel sides 36, 38 of the bus 12 are defined by solar panels, while the two wake sides 32, 34 of the bus 12 are defined by non-solar panels. Referring to FIGS. 11 and 13, in the illustrated embodiment, the satellite 10 includes a hot side 122 and a cold side 124, as will be discussed in more detail below. The bus panels on the hot side 122 of the satellite 10 are all solar panels (shown in FIG. 11 only), while the bus panels on the cold side 124 of the satellite 10 are all non-solar panels. The bus panels are positionally fixed to the bus frame 132 and define portions of the bus outer profile 22, and thus the bus panels may be characterized as “frame-mounted” or “body-mounted” panels. In the illustrated embodiment, all of the solar panels of the bus 12 are body-mounted solar panels. In other embodiments, the bus 12 includes at least one solar panel that is not a body-mounted, such as a flip-out solar panel.

Referring again to FIG. 15, the payload interface end 134 of the bus frame 132 is connected to the bus interface end 116 of the payload frame 112. In some embodiments, the satellite 10 includes an isolator at the interface between the bus frame 132 and the payload frame 112. In such embodiments, the isolator is configured to reduce or eliminate transmissibility of vibration one or more components in the bus 12, on the one hand, to the remote sensing system 16 in the payload 14, on the other hand. For example, the reduction or elimination of vibration aids in reducing or eliminating blur or smear in the digital images generated by the remote sensing system 16, and thereby aids in achieving the desired high-resolution of the digital images.

Referring to FIGS. 9-14, in the illustrated embodiment, the satellite 10 is configured such that the bus outer profile 22 and the payload outer profile 52 are defined at least substantially by body-mounted panels (e.g., solar panels and non-solar panels). The satellite 10 includes two thrusters 68, 70 and two star trackers 72, 74, but otherwise excludes substantial appendages or deployable devices that would noticeably change the respective shapes of the bus outer profile 22 and the payload outer profile 52 (e.g., a non-body-mounted solar panel, a dish antenna, etc.). This has the effect of improving the overall structural dynamics of the satellite 10 during orbital operation, which reduces or eliminates blur or smear in the digital images generated by the remote sensing system 16, and thereby aids in achieving the desired high-resolution of the digital images.

Referring to FIGS. 1 and 2, the satellite 10 is configured to be delivered to a predetermined orbit 26 of the Earth 24 by a launch vehicle (not shown). During launch, the satellite 10 is removably connected to the launch vehicle via the launch vehicle adapter 140 mounted to the zenith deck panel 138 of the bus 12 (see FIGS. 9, 10, 11, 12, and 14). The satellite 10 is configured to perform remote sensing (e.g., imaging) while traveling in the predetermined orbit 26. During a nominal orbit operation of the satellite 10, the intended velocity direction 42 of the satellite 10 is in the +X direction and the satellite is in a low-drag orbit-maintenance-ready attitude. The data provided by the star trackers 72, 74 allows the attitude control device 128 to determine at least the attitude of the satellite 10 relative to a celestial reference. This allows the attitude control device 128 to: adjust the attitude of the satellite 10 for maintaining the line of sight 20 of the system 16 in a nominally nadir-pointing direction for remote sensing of Earth; prevent exposure of the aperture 88 to light 90 transmitted directly from the Sun 120; and reduce exposure of the aperture 88 to the atomic oxygen that may be present in the ambient environment when the satellite 10 is operated at VLEO. The data provided by the star trackers 72, 74 also allows the attitude control device 128 to adjust the attitude of the satellite 10 for conforming with one or more thermal constraints. For example, referring to FIG. 2, in embodiments in which the satellite 10 includes a hot side 122 and a cold side 124 (see FIGS. 11 and 13), the attitude control device 128 is configured to adjust the attitude of the satellite 10 so that the cold side 124 is only directed toward the Sun 120, if at all, during a shadow portion 144 of the orbit 26.

The satellite 10 is configured to be operated in modes such as sensing mode, cruise mode, downlink mode, or orbit maintenance mode. During the sensing mode, the attitude control device 128 controls the attitude of the satellite 10 to permit the remote sensing system 16 of the payload 14 to capture high-performance remote sensing data (e.g., digital image pixel data) of one or more desired regions of Earth 24. During the cruise mode, the attitude control device 128 controls the attitude of the satellite 10 to maximize exposure of the body-mounted solar panels to the light 90 from the Sun 120, while minimizing the ram-facing cross-sectional area to reduce aerodynamic drag when the satellite 10 is operated at VLEO. During the downlink mode, the attitude control device 128 controls the attitude of the satellite 10 to permit the transmission of remote sensing data (e.g., digital image pixel data) from the satellite 10 to one or more ground stations 106 (see FIG. 1). During the orbit maintenance mode, the attitude control device 128 controls the attitude of the satellite 10 to permit the thrusters 68, 70 to generate thrust for a controllable duration for maintaining the satellite 10 at the predetermined orbital altitude over the predetermined mission lifetime.

The present satellite 10 provides significant advantages. Whereas prior art VLEO vehicle concepts are typically designed around an airplane or tube-like structure that precludes integration of large-aperture remote sensing systems needed for higher image resolutions, the present satellite 10 has a mechanical layout that hosts large-aperture systems in a naturally nadir-facing, Earth-imaging-ready, and low-drag attitude for operating at VLEO or other low altitude orbits. These advantages stem in part from the respective elongate polygonal shapes of the bus outer profile 22 and the payload outer profile 52 (see FIGS. 4 and 5). As discussed above, there is a need to minimize drag when operating at VLEO. Less drag also means lower power requirements for maintaining the desired orbital altitude, which in turn makes it easier satisfy volume and mass constraints. Prior art VLEO vehicles typically minimize drag by going to extreme lengths to minimize the ram-facing cross-sectional area of the vehicle at the cost of mission payload accommodation.

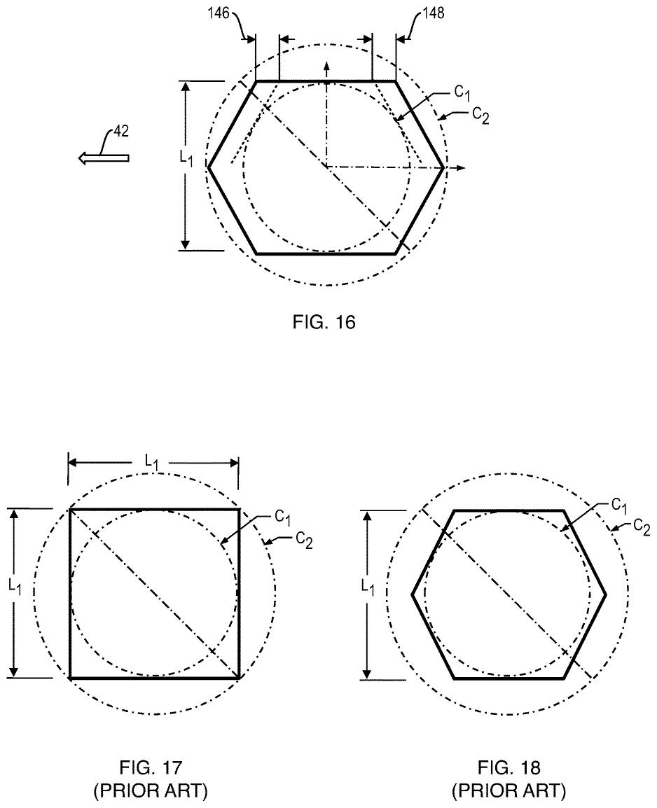

Referring to FIGS. 16-18, the elongate polygonal (e.g., elongate hexagonal) shape of the bus outer profile 22 (FIG. 16) maintains the same ram-facing cross-sectional area as a prior art vehicle with a square-shaped bus outer profile (FIG. 17) or an equilateral hexagonal-shaped bus outer profile (FIG. 18), and it does so while increasing the area enclosed by the bus outer profile 22. FIGS. 16-18 show that the diameters of the inscribed circles C₁ and the circumscribed circles C₂ are the same for the elongate hexagon (FIG. 16), the square (FIG. 17) and the regular hexagon (FIG. 18). The inscribed circles C₁ are representative of the maximum diameter of the aperture of the remote sensing system provided in the payload, and the circumscribed circles C₂ are representative of a volume constraint that may be provided by a launch provider. As seen in FIG. 16, the added area defined by the elongate hexagonal shape provides gaps 146, 148 between the inscribed circle C₁ and the sides defining the elongate hexagonal shape. The gaps 146, 148 translate to extra volume in the bus 12 for enclosing infrastructure that enables the payload 14 to generate high-resolution digital images as discussed above. The corresponding elongate polygonal shape of the payload outer profile 52 (FIG. 5) takes advantage of the added volume by packing the telescope 18 in a naturally Nadir-facing orientation proximate the leading edge 76 of the payload 14, while providing a shaded cold face with substantially increased area for removing heat from the payload 14 by truncating the shape to make the wake side 66 that extends between the two converging wake sides 58, 60.

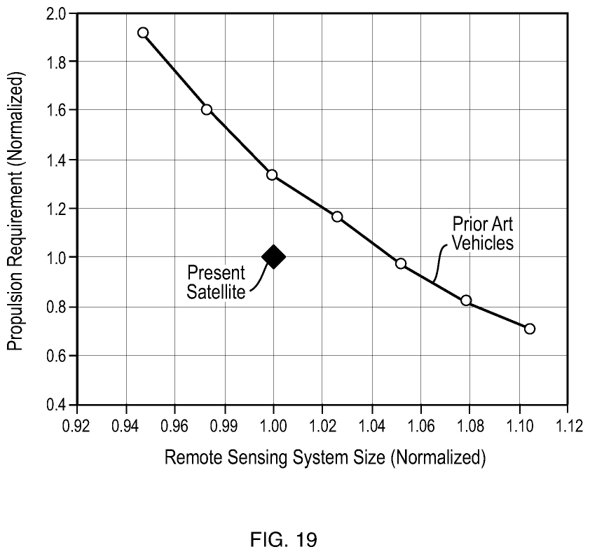

The respective elongate polygonal shapes of the bus outer profile 22 and the payload outer profile 52 provide a surprising and elegant solution for minimizing drag on the satellite 10 while maximizing the ballistic coefficient and mission capacity. Referring to FIG. 19, the respective elongate polygonal shapes of the bus outer profile 22 and the payload outer profile 52 allow the present satellite 10 to have a size and a propulsion requirement that are substantially less than those of prior art satellites with comparable remote sensing systems. The unconventional and irregular shapes of the bus outer profile 22 and the payload outer profile 52 require more complex design, analysis, and considerations than conventionally-shaped profiles (e.g., square-shaped profiles). However, the elongate polygonal shapes allow the present satellite 10 to achieve a volume capable of packaging the necessary components within a same ram-facing cross-sectional area as a satellite with a square-shaped profile, while maintaining most of the structural strength and dynamic stability benefits of a satellite profile having a regular (e.g., equilateral) polygonal shape.

By truncating the respective elongated polygonal shapes of one or both of the bus outer profile 22 and the payload outer profile 52, as described above, the satellite 10 provides a large surface (e.g., the surface defined by the additional wake side 66) that is ideal for radiator operation. The position of this radiator surface substantially opposite the respective leading edges 46, 76 of the bus 12 and payload 14—which are on the Sun-facing hot side 122 of the satellite 10—advantageously maximizes radiator size and performance and provides a convenient location for mounting components that should or must be kept away from the Sun (e.g., the star trackers 72, 74).

The present method for operating the satellite 10 includes at least the step of maintaining a nominal attitude of the satellite 10 in which the rotational symmetry axis 44 of the bus outer profile 22 extends at least substantially parallel relative to the intended velocity direction 42 during travel in a low or very low Earth orbit. This orients the satellite 10 such that the respective leading edges 46, 76 of the bus 12 and payload 14 are in fact leading during travel in the intended velocity direction 42. This also provides a reduction in coefficient of drag that further minimizes propulsion requirements, which enables operation of the satellite 10 in VLEO, for example.

While several embodiments have been disclosed, it will be apparent to those having ordinary skill in the art that aspects of the present invention include many more embodiments. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

1. A satellite, comprising:
a bus; and
a payload disposed relative to the bus, the payload including a remote sensing system that defines a line of sight;
wherein the bus is configured such that, in a cross-sectional plane that extends at least substantially normal relative to the line of sight, a bus outer profile defines an elongate shape that is at least substantially polygonal; and
wherein the elongate shape of the bus outer profile corresponds to an equilateral polygonal shape that has been elongated at least in a direction that is substantially parallel relative to an intended velocity direction during a nominal orbit operation of the satellite.

2. The satellite of claim 1, wherein the remote sensing system is configured to generate digital images of Earth during a very low Earth orbit, the digital images having native resolution better than 30 cm/pixel.

3. The satellite of claim 1, wherein the elongate shape of the bus outer profile is an elongate hexagonal shape.

4. (canceled)

5. The satellite of claim 1, wherein the elongate shape of the bus outer profile is formed by a plurality of at least substantially straight sides that meet at a plurality of vertices.

6. The satellite of claim 1, wherein the elongate shape of the bus outer profile is defined in part by a first ram-facing side and a second ram-facing side; and
wherein the elongate shape of the bus outer profile is rotationally symmetric about an axis that intersects a vertex where the first ram-facing side and the second ram-facing side meet to define a portion of a leading edge of the bus.

7. The satellite of claim 6, wherein the axis extends at least substantially normal relative to the line of sight.

8. The satellite of claim 1, wherein the bus outer profile is defined by at least a first ram-facing side, a second ram-facing side, a first parallel side, a second parallel side, a first wake side, and a second wake side;
wherein the first parallel side extends between the first ram-facing side and the first wake side;
wherein the second parallel side extends between the second ram-facing side and the second wake side; and
wherein the first and second parallel sides extend at least substantially parallel relative to one another.

9. The satellite of claim 8, wherein the first parallel side and second parallel side each have a length that is greater than respective lengths of the first ram-facing side, the second ram-facing side, the first wake side, and the second wake side.

10. The satellite of claim 8, wherein the satellite is configured such that the first parallel side and second parallel side of the bus outer profile are at least substantially parallel relative to an intended velocity direction during a nominal orbit operation of the satellite.

11. The satellite of claim 8, wherein the first ram-facing side and the second ram-facing side meet to define a portion of a leading edge of the bus;
wherein the first wake side and the second wake side meet to define a portion of a trailing edge of the bus.

12. The satellite of claim 1, wherein the bus has an at least substantially polyhedral shape such that, in at least a plurality of cross-sectional planes that each extend at least substantially normal relative to the line of sight, the bus outer profile has a same elongate shape that is at least substantially polygonal.

13. The satellite of claim 12, wherein the elongate shape is an elongate hexagonal shape.

14. The satellite of claim 1, wherein the payload is configured such that, in a second cross-sectional plane that extends normal relative to the line of sight, a payload outer profile defines an elongate shape that is at least substantially polygonal.

15. The satellite of claim 14, wherein the elongate shape of the payload outer profile is different than the elongate polygonal shape of the bus outer profile.

16. The satellite of claim 14, wherein the elongate shape of the bus outer profile is formed by n sides and the elongate shape of the payload outer profile is formed by n+1 sides.

17. The satellite of claim 14, wherein the elongate shape of the payload outer profile is a truncated version the elongate polygonal shape of the bus outer profile.

18. The satellite of claim 14, wherein the elongate shape of the payload outer profile corresponds to the elongate shape of the bus outer profile except the elongate shape of the payload outer profile includes an additional wake side.

19. The satellite of claim 14, wherein the payload outer profile is defined by a first ram-facing side, a second ram-facing side, a first parallel side, a second parallel side, a first wake side, a second wake side, and a third wake side;
wherein the first parallel side extends between the first ram-facing side and the first wake side;
wherein the second parallel side extends between the second ram-facing side and the second wake side;
wherein the first and second parallel sides extend at least substantially parallel relative to one another; and
wherein the third wake side extends between the first and second wake sides.

20. The satellite of claim 19, wherein the elongate shape of the payload outer profile is rotationally symmetric about an axis that intersects a vertex where the first ram-facing side and the second ram-facing side meet to define a portion of a leading edge of the payload; and
wherein the third wake side is at least substantially normal relative to the axis.

21. The satellite of claim 20, wherein the axis extends at least substantially normal relative to the line of sight.

22. The satellite of claim 14, wherein the payload has an at least substantially polyhedral shape such that, in at least a plurality of cross-sectional planes that each extend at least substantially normal relative to the line of sight, the payload outer profile has a same elongate shape that is at least substantially polygonal.

23. The satellite of claim 14, wherein the payload includes at least two star trackers configured to generate data indicative attitude of the satellite relative to a celestial reference; and
wherein each of the at least two star trackers is positionally fixed relative to a wake side of the payload such that a field of view of the respective star tracker is not obstructed by the bus.

24. The satellite of claim 1, wherein the payload includes at least one thruster configured to generate thrust for a controllable duration for maintaining the satellite at a predetermined orbital altitude for a predetermined mission lifetime; and
wherein the at least one thruster is positionally fixed relative to a wake side of the payload.

25. The satellite of claim 24, wherein the at least one thruster is an ion thruster.

26. The satellite of claim 24, wherein the at least one thruster is configured to generate thrust for a controllable duration in a direction that is at least substantially opposite an intended velocity direction during a nominal orbit operation of the satellite.

27. The satellite of claim 24, wherein the at least one thruster is configured to generate thrust for a controllable duration along a thrust axis that at least substantially intersects the center of mass of the satellite.

28. The satellite of claim 1, wherein the bus and the payload define a leading edge of the satellite; and
wherein the leading edge extends at least substantially parallel to the line of sight.

29. The satellite of claim 1, wherein the remote sensing system includes a telescope configured to collect and focus light, and an imaging sensor configured to transform the focused light from the telescope into digital image pixel data.

30. The satellite of claim 29, wherein the telescope has an aperture with a diameter that is at least 20 cm.

31. The satellite of claim 1, wherein the satellite includes a hot side and a cold side;
wherein the payload includes a payload frame to which a plurality of payload panels are positionally fixed to define a sealed internal cavity suitable for enclosing components such that the components are protected from at least one of direct exposure to light from the Sun and corrosive atomic oxygen in an ambient environment;
wherein a first subset of the plurality of payload panels are disposed on the hot side of the satellite, and a second subset of the plurality of payload panels are disposed on the cold side of the satellite; and
wherein payload panels of the first subset are solar panels, and payload panels of the second subset are not solar panels.

32. The satellite of claim 1, wherein the satellite includes a hot side and a cold side;
wherein the bus includes a bus frame to which a plurality of bus panels are positionally fixed to define a sealed internal cavity suitable for enclosing components such that the components are protected from at least one of direct exposure to light from the Sun and corrosive atomic oxygen in an ambient environment;
wherein a first subset of the plurality of bus panels are disposed on the hot side of the satellite, and a second subset of the plurality of bus panels are disposed on the cold side of the satellite; and
wherein bus panels of the first subset are solar panels, and bus panels of the second subset are not solar panels.

33. The satellite of claim 1, further comprising a plurality of solar panels;
wherein the plurality of solar panels are all body-mounted solar panels.

34. The satellite of claim 1, wherein the remote sensing system is configured to perform Earth imaging while maintaining a predetermined orbit for a predetermined mission lifetime.

35. The satellite of claim 34, wherein the predetermined orbit is a very low Earth orbit; and
wherein the predetermined mission lifetime is more than 1 year.

36-39. (canceled)

40. A method for operating a satellite having a bus and a payload disposed relative to the bus, the payload including a remote sensing system with a telescope that defines a line of sight, and the bus configured such that, in a cross-sectional plane that extends at least substantially normal relative to the line of sight, a bus outer profile defines an elongate shape that is at least substantially polygonal, the method comprising:
maintaining a nominal attitude of the satellite in which a rotational symmetry axis of the bus outer profile extends at least substantially parallel relative to an intended velocity direction during a nominal orbit operation of the satellite.

41. The method of claim 40, wherein the elongate shape of the bus outer profile corresponds to an equilateral polygonal shape that has been elongated at least in a direction that is substantially parallel relative to an intended velocity direction during a nominal orbit operation of the satellite.
